(19) United States
(12) Patent Application Publication
(10) Pub. No.: US 2015/0379129 A1
(43) Pub. Date: Dec. 31, 2015

(54) METHOD AND APPARATUS OF SELECTING EXPANSION TERM PAIRS

(71) Applicant: Alibaba Group Holding Limited, Grand Cayman (KY)

(72) Inventors: Wei He, Hangzhou (CN); Feng Lin, Hangzhou (CN); Bo Li, Hangzhou (CN)

(21) Appl. No.: 14/754,449

(22) Filed: Jun. 29, 2015

(30) Foreign Application Priority Data
Jun. 30, 2014 (CN) 201410306347.9

(51) Int. Cl. G06F 17/30

(52) U.S. Cl. CPC G06F 17/30864; G06F 17/30498

(57) ABSTRACT

A method of selecting expansion term pairs to solve a problem that only a relatively small number of expansion term pairs may be determined under a circumstance of not enough user activities according to an existing method of determining an expansion term pair is disclosed. The method includes: acquiring at least two query term pairs, each query term pair including at least one query term as a bid-word; determining query term pairs in which a respective co-occurrence number of each query term included in a specific period of time is less than a first number-of-time threshold from among the at least two query term pairs; and selecting query term pair(s) that satisf(ies) a configured expansion term pair necessary condition as expansion term pair(s) from among the determined query term pairs. The present disclosure further discloses an apparatus of selecting expansion term pairs.

### CROSS REFERENCE TO RELATED PATENT APPLICATION

This application claims foreign priority to Chinese Patent Application No. 201410306347.9 filed on Jun. 30, 2014, entitled “Method and Apparatus of Selecting Expansion Term Pairs”, which is hereby incorporated by reference in its entirety.

### TECHNICAL FIELD

The present disclosure relates to the field of computer technologies, and in particular, to methods and apparatuses of screening expansion term pairs.

### BACKGROUND

Nowadays, advertisers usually “purchase” keywords to promote products thereof in at least some websites, and these purchased keywords are also referred to as “bid-words.” When a user subsequently uses a bid-word or other term as a query to search for a product, an advertisement fee deduction system will deduct an advertisement fee for a single click from an account of an advertiser according to a bid-word charging standard that matches with the query used by the user if the user finds information of a promoted product (which is also referred to as exposure), and performs a click thereon.

Generally, a scenario in which information of a promoted product is found by using a bid-word as a query is referred to as an “exact match”. A scenario in which information of a promoted product is found by using other terms as a query is referred to as an “expanded match”.

For an expanded match, in order to determine a bid-word charging standard that matches with a query, a bid-word matching with the query needs to be determined first. A term pair constructed from an individual bid-word and an individual query term matching with the individual bid-word may be referred to as an “expansion term pair”. In particular, two terms included in an expansion term pair may be bid-words.

In existing technologies, an expansion term pair may be determined based on user activities. A specific implementation is given as follows:

First, for some query terms, a determination is made as to whether a user performs a specific action on a same piece of product information according to each query term among those query terms respectively. Generally, the specific action described herein is a search behavior, a click behavior, an order making behavior (which is a unique behavior in an electronic commerce website) or a feedback behavior (for example, the user provides a comment on a product).

If a result of the determination is affirmative, from among the query terms, a determination is made as to whether a bid-word exists in respective query term pairs generated from combinations of two query terms based on a bid-word database.

Finally, from query term pairs that include the bid-word, a query term pair, which number of times each query term included therein is used by an individual user as a basis for search in a specific period of time is not less than a set number-of-time threshold, is selected as an expansion term pair. The number of times that the individual user uses as the basis for the search is referred to as a “co-occurrence number”.

A deficiency of the aforementioned method of determining an expansion term pair mode is that query term pairs satisfying a condition that a co-occurrence number of each query term thereof in a particular period of time is not less than a set number-of-time threshold are few under a circumstance of few user activities, thus leading to a relatively small number of expansion term pairs determined thereby and possibly failing to meet a demand in reality.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

Embodiments of the present disclosure provide a method of selecting expansion term pairs to solve a problem that only a relatively small number of expansion term pairs may be determined under a circumstance of not enough user activities according to an existing method of determining an expansion term pair.

The embodiments of the present disclosure further provide an apparatus of selecting expansion term pairs to solve the problem that only a relatively small number of expansion term pairs may be determined under a circumstance of not enough user activities according to an existing method of determining an expansion term pair.

The embodiments of the present disclosure employ technical solutions as follows:

A method of selecting an expansion term pair, which includes: acquiring at least two query term pairs, each query term pair including at least one query term as a bid-word; determining query term pairs in which a respective number of times of co-occurrence of each query term included in a specific period of time is less than a first number-of-time threshold from among the at least two query term pairs; and selecting query term pair(s) that satisf(ies) a configured expansion term pair necessary condition as expansion term pair(s) from among the determined query term pairs.

An apparatus of selecting an expansion term pair, which includes: an acquisition unit to acquire at least two query term pairs, wherein each query term pair includes at least one query word as a bid-word; a first determination unit to determine query term pairs in which a respective number of times of co-occurrence of each query term included in a specific period of time is less than a first number-of-time threshold from among the at least two query term pairs acquired by the acquisition unit; and a selection unit to select a query term pair that satisfies a set expansion term pair necessary condition as an expansion term pair from among the query term pairs determined by the first determination unit.

By employing at least one of the above technical solutions, the embodiments of the present disclosure may achieve beneficial effects as follows:

Since query terms may be selected as expansion term pairs from query term pairs in which a respective co-occurrence number of each query term included in a particular period of time is less than a first number-of-time threshold according to a set expansion term pair necessary condition, more expansion term pairs may be acquired even in a scenario where few query term pairs in which respective co-occurrence numbers of query terms included in a particular period of time are not less than a set number-of-time threshold due to insufficient user activities. Thus, this solves the problem that only a relatively small number of expansion term pairs may be determined under a circumstance of not enough user activities according to an existing method of determining an expansion term pair.

### BRIEF DESCRIPTION OF THE DRAWINGS

Accompanying drawings described herein are provided for further understanding of the present disclosure, and constitute a part of the present disclosure. Schematic embodiments of the present disclosure and a description thereof are used to illustrate the present disclosure, and are not construed as any improper limitations of the present disclosure. In the accompanying drawings:

FIG. 1 is a flowchart illustrating an example method of selecting expansion term pairs according to the present disclosure.

FIG. 2 is a flowchart illustrating another example method of selecting expansion term pairs according to the present disclosure.

FIG. 3 is a structural diagram illustrating an example apparatus of selecting expansion term pairs according to the present disclosure.

FIG. 4 is a structural diagram illustrating the example apparatus of FIG. 3 in more detail.

### DETAILED DESCRIPTION

To make the objectives, technical solutions and advantages of the present disclosure clearer, the technical solutions of the present disclosure will be described clearly and completely herein with reference to exemplary embodiments and corresponding accompanying drawings of the present disclosure. Apparently, the described embodiments relate to only some of the embodiments rather than all embodiments of the present disclosure. Based on the embodiments in the present disclosure, all other embodiments acquired by one of ordinary skill in the art without making any creative effort shall belong to the protection scope of the present disclosure.

The technical solutions provided by the embodiments of the present disclosure are described in detail herein with reference to the accompanying drawings.

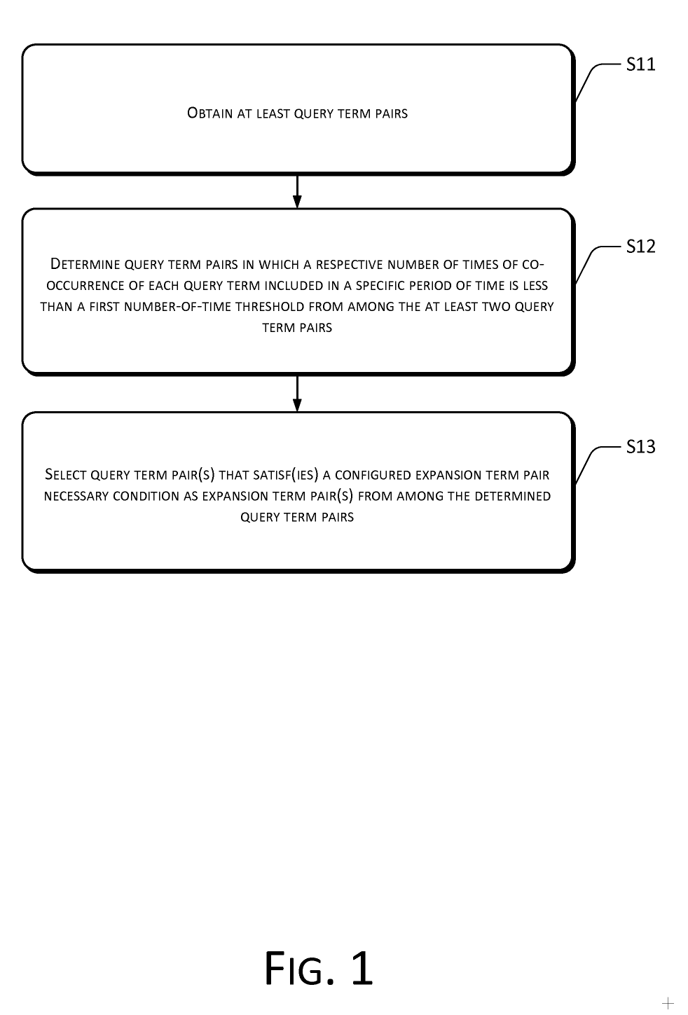

To solve the problem that a relatively small number of expansion term pairs may be determined under a circumstance of not enough user activities according to an existing method of determining an expansion term pair, an embodiment of the present disclosure provides a method of selecting expansion term pairs. FIG. 1 shows a flowchart of that method, which includes the following method blocks:

Block S11 obtains at least two query term pairs.

Each query term pair includes at least one query term as a bid-word.

Block S12 determines query term pair(s) in which a respective number of times of co-occurrence of each query term included in a specific period of time is less than a first number-of-time threshold from among the at least two query term pairs obtained at block S11.

The specific period of time described herein may include one or more sessions, or may include another designated period of time (for example, the past three months), etc. Specifically, in an implementation, the at least two query term pairs may come from different user sessions. For example, the at least two query term pairs that are obtained include at least: a first query term pair that is used by a first user as a basis for search in a specific period of time, and a second query term pair that is used by a second user as a basis for search in the specific period of time.

A session corresponds to a time duration of a communication between an individual user terminal in a particular state and an opposite end of the communication (which is usually a website server), and generally corresponds to a length of time that is elapsed from logging into a website to logging out of the website by the user terminal.

In an event that the at least two query term pairs that are obtained come from different user sessions, an example implementation process of block S12 may include the following sub-blocks:

separately performing for each query term pair that is included in the at least two query term pairs and is only used by a single user as a basis for search in a particular period of time: determining a respective number of times that the query term pair is used by a single user as a basis for search in the particular period of time;

separately performing for each query term pair that is included in the at least two query term pairs and is used by at least two users as a basis for search in the particular period of time: determining a respective total number of times that the query term pair is used by the users as a basis for search respectively in the particular period of time; and

based on the respective number of times determined for each query term pair in the at least two query term pairs and only used by a single user in the particular period of time and the determined total number of times, determining a query term pair in which a respective co-occurrence number of each query term included in the particular period of time is less than a first number-of-time threshold.

In an embodiment of the present disclosure, a query term pair in which a respective co-occurrence number of each query term included in the particular period of time is greater than or equal to the first number-of-time threshold may be considered as a high-confidence term pair, and may be used as an expansion term pair. A query term pair in which a respective co-occurrence number of each query term included in the particular period of time is less than the first number-of-time threshold may be considered as a low-confidence term pair, and may be further mined. Details thereof are described as follows.

Block S13 selects a query term pair that satisfies a pre-determined expansion term pair condition as an expansion term pair from among the query term pairs determined at block S12 (i.e., low-confidence term pairs).

In the foregoing method provided by the embodiment of the present disclosure, since query terms may be selected as expansion term pairs from query term pairs in which a respective co-occurrence number of each query term included in a particular period of time is less than a first number-of-time threshold according to a pre-determined expansion term pair condition, more expansion term pairs may be acquired even in a scenario where few query term pairs in which respective co-occurrence numbers of query terms included in a particular period of time are not less than a set number-of-time threshold due to insufficient user activities. Thus, this solves the problem that only a relatively small number of expansion term pairs may be determined under a circumstance of not enough user activities according to an existing method of determining an expansion term pair. Apparently, in some implementations, mining may further be performed for expansion terms with reference to user activities.

In an embodiment of the present disclosure, block S13 may be implemented by using (but not limited to) the following approaches, details of which are described as follows.

A First Approach:

Based on a respective number of times of each query term included in the query term pairs that are determined at block S12 that is used by different users as a basis for search in the particular period of time, a query term pair that satisfies a pre-determined expansion term pair condition is selected from among the determined query term pairs as an expansion term pair.

In the first approach, the expansion term pair condition may include: the respective number of times of each included query term that is used by different users as a basis for search in the particular period of time being greater than a second number-of-time threshold.

A Second Approach:

Based on a coincidence degree of query term units of each query term in the query term pairs that are determined at block S12, a query term pair that satisfies a pre-determined expansion term pair condition is selected from among the determined query term pairs as an expansion term pair.

A “query term unit” described herein is referred to as term units that are acquired by performing word segmentation on a query term. For example, term units “Norway”, “imported” and “salmon” may be acquired by performing word segmentation on a query term “imported salmon from Norway”. In an embodiment of the present disclosure, word segmentation of a query term may be implemented by using a word segmentation technology in existing technologies.

In the second approach, the expansion term pair condition may include satisfying a query term unit coincidence condition.

A meaning of the query term unit coincidence condition is that:

if an individual query term pair includes a first query term and a second query term, the query term unit coincidence condition includes: at least one query term unit in query term units of the first query term being the same as a query term unit of the second query term. In other words, the first query term and the second query term are semantically related to each other to a certain extent.

A Third Approach:

According to a lift degree among respective query terms included in each query term pair that is determined at block S12, a query term pair that satisfies a pre-determined expansion term pair condition is selected from the determined query term pairs as an expansion term pair.

If an individual query term pair includes a first query term and a second query term, a formula for calculating a lift degree lift (Q₁, Q₂) between the first query term and the second query term is given as the following formula [1]:

$$lift ( {Q}_{1} , {Q}_{2} ) = \frac{P ( {Q}_{1} , {Q}_{2} )}{P ( {Q}_{1} ) P ( {Q}_{2} )} \qquad [ 1 ]$$

A method of calculating P (Q₁, Q₂) in the formula [1] is given in the following formula [2]:

$$P ( {Q}_{1} , {Q}_{2} ) = \frac{n}{N} \qquad [ 2 ]$$

In the formula [2], n is a total number of times that the first query term and the second query term are used by particular users as a basis for search in the particular period of time. N is a total number of times that query terms included in the query term pairs determined at block S12 are used by the particular users as a basis for search in the particular period of time. The “particular users” described herein are referred to as users who use the query terms determined at block S12 as a basis for search in the particular period of time.

By way of example, for a query term pair that includes a first query term “A” and a second query term “B”, if the query term pairs determined at block S12 are {A, B} and {B, C}, and if the particular users include a first user, a second user and a third user, a determination may be made based on the formula [2] for a situation when the first user and the second user both use “A” and “B” to search for products in a particular period of time, and the first user, the second user and the third user all use “B” and “C” to search for products in that particular period of time: a total number of times that “A” and “B” are used by the particular users as a basis for search in the particular period of time is two, and a total number of times that “B” and “C” are used by the particular users as a basis for search in the particular period of time is three, and thus n=2, and N=2+3=5. Therefore, based on the formula [2], P(Q₁, Q₂) corresponding to {A, B} may be calculated as P(Q₁, Q₂)=2/5=0.4.

A method of calculating P(Q₁) in the formula [1] is given in the following formula [3]:

$$P ( {Q}_{1} ) = \frac{m}{M} \qquad [ 3 ]$$

m is a total number of times of the first query term being used by the particular users as a basis for search in the particular period of time. M is a sum of respective numbers of times that the query terms included in the query term pairs determined at block S12 are used by the particular users as a basis for search in the particular period of time.

Based on the formula [3], for example, it is still assumed that the query term pairs determined at block S12 are {A, B} and {B, C}, and the particular users include a first user, a second user and a third user. When the first user and the second user both have used “A” to search for products in the particular period of time and a total number of times that “A” is used is five, m=5. If numbers of times that the first user, the second user and the third user use “B” to search for products in that particular period of time are one, one and four respectively, and respective numbers of times that “C” is used to search for products are one, one and three, M=m+1+1+4+1+1+3=16. Therefore, according to the formula [3], P(Q₁) corresponding to A may be calculated as P(Q₁)=5/16=0.3125.

A method of calculating P(Q₂) in the formula [1] is given in the following formula [4]:

$$P ( {Q}_{2} ) = \frac{l}{L} \qquad [ 4 ]$$

I is a total number of times of the second query term being used by the particular users as a basis for search in the particular period of time. L is a sum of respective numbers of times that the query terms included in the query term pairs determined at block S12 are used by the particular users as a basis for search in the particular period of time.

Based on the formula [4], for example, it is still assumed that the query term pairs determined at block S12 are {A, B} and {B, C}, and the particular users include a first user, a second user and a third user. If the first user and the second user both use “B” to search for products in the particular period of time and a total number of times that “B” is used is six, I=6. If a total number of times that the first user, the second user and the third user use “A” to search for products in that particular period of time is five, and a total number of times that “C” is used to search for products is also five, L=I+5+5=16. According to the formula [4], P(Q₂) corresponding to B may be calculated as P(Q₂)=6/16=0.375.

For the query term pair {A, B}, after obtaining P(Q₁)=0.3125, P(Q₂)=0.375 and P(Q₁, Q₂)=0.4, a lift degree lift(Q₁, Q₂)=0.4/(0.3125×0.375)≈3.4 between A and B may further be calculated according to the formula [1].

In an implementation, if a value of the determined lift degree is greater than a lift degree threshold, a determination may be made that a corresponding query term pair satisfies the expansion term pair condition, and thus an affirmative determination may further be made that this query term pair may be used as an expansion term pair.

For example, if the lift degree threshold is one, when the lift degree determined for the query term pair {A, B} is lift (Q₁, Q₂)≈3.4, the query term pair {A, B} may be determined to be used as an expansion term pair.

A Fourth Approach:

According to a respective number of times that each query term in the query term pairs determined at block S12 is used by different users as a basis for search in a particular period of time and a coincidence degree of query term units of the query terms in the determined query term pairs, a query term pair that satisfies a pre-determined expansion term pair condition is selected from the determined query term pairs as an expansion term pair.

In the fourth approach, the expansion term pair condition may include: the respective number of times that each included query term is used by different users as a basis for search in the particular period of time being greater than a second number-of-time threshold, and satisfying a query word unit coincidence condition as described above.

A Fifth Approach:

According to a respective number of times that each query term in the query term pairs determined at block S12 is used by different users as a basis for search in a particular period of time and a respective lift degree between query terms in each determined query term pair, a query term pair that satisfies a pre-determined expansion term pair condition is selected from the determined query term pairs as an expansion term pair.

In the fifth approach, the expansion term pair condition may include: the respective number of times that each included query term is used by different users as a basis for search in the particular period of time being greater than a second number-of-time threshold, and a value of the respective lift degree between included query terms is greater than a lift degree threshold.

A Sixth Approach:

According to a respective coincidence degree of query term units of the query terms in the query term pairs determined at block S12 and a respective lift degree between query terms in each determined query term pair, a query term pair that satisfies a pre-determined expansion term pair necessary condition is selected from the determined query term pairs as an expansion term pair.

In the sixth approach, the expansion term pair necessary condition may include: satisfying the query term unit coincidence condition as described above, and a value of the respective lift degree between the included query terms being greater than a lift degree threshold.

A Seventh Approach:

According to a respective number of times that each query term in the query term pairs determined at block S12 is used by different users as a basis for search in a particular period of time, a respective coincidence degree of query term units of the query terms in the determined query term pairs and a lift degree between query terms in each determined query term pair, a query term pair that satisfies a set expansion term pair necessary condition is selected from the determined query term pairs as an expansion term pair.

In the seventh approach, the expansion term pair necessary condition may include: the respective number of times that each included query term is used by different users as a basis for search in the particular period of time being greater than a second number-of-time threshold, satisfying the query word unit coincidence condition, and a value of the respective lift degree between the included query terms being greater than a lift degree threshold.

It should be noted that the process of selecting query term pairs according to lift degrees generally consumes a relatively large amount of computing resources. As such, if a number of times, a coincidence degree and a lift degree as described above are used as a basis for selecting query term pairs, the number of times may be used as a basis for selecting query term pairs to select query term pairs (for ease of description, the query term pair(s) selected here is/are referred to as “a first part of query term pairs” hereinafter) from the query term pairs determined at block S12 first. The coincidence degree may then be used as a basis for selecting query term pairs to further select query term pairs (for ease of description, the query term pairs selected herein are referred to as “a second part of query term pairs” hereinafter) from the first part of query term pairs. Finally, the lift degree may be used as a basis for selecting query term pairs to select query term pairs (for ease of description, the query term pairs selected herein are referred to as “a third part of query term pairs” hereinafter) from the second part of query term pairs. The first part of query term pairs satisfy a condition that a respective number of times that each included query term is used by different users as a basis for search in a particular period of time is greater than a second number-of-time threshold. The second part of query term pairs satisfy a query word unit coincidence condition. The third part of query term pairs satisfy a condition that a value of a respective lift degree between included query terms is greater than a lift degree threshold.

By using the above selection method, an operation of calculating lift degrees only needs to be performed on the second part of query term pairs when query term pairs are selected according to the lift degrees. Since a total number of the second part of query term pairs is generally less than (and usually far less than) a total number of the query term pairs determined at block S12, this selection method may achieve a purpose of saving computing resources as compared with the method that selects query term pairs based on the lift degrees first.

Optionally, in the seventh approach, the coincidence degree, the number of times and the lift degree may also be used sequentially as a basis for selecting the query term pairs.

In an embodiment of the present disclosure, whether to use the number of times or the coincidence degree as a first basis for selecting query term pairs depends on specific scenarios. Generally, if X<Y, a determination may be made that the number of times is used as the first basis for selecting the query term pairs; otherwise, a determination may be made that the coincidence degree is used as the first basis for selecting the query term pairs, where X is a number of query term pairs selected from the query term pairs determined at block S12 using the number of times as a basis for selecting query term pairs, and Y is a number of query term pairs selected from the query term pairs determined at block S12 using the coincidence degree as a basis for selecting query term pairs.

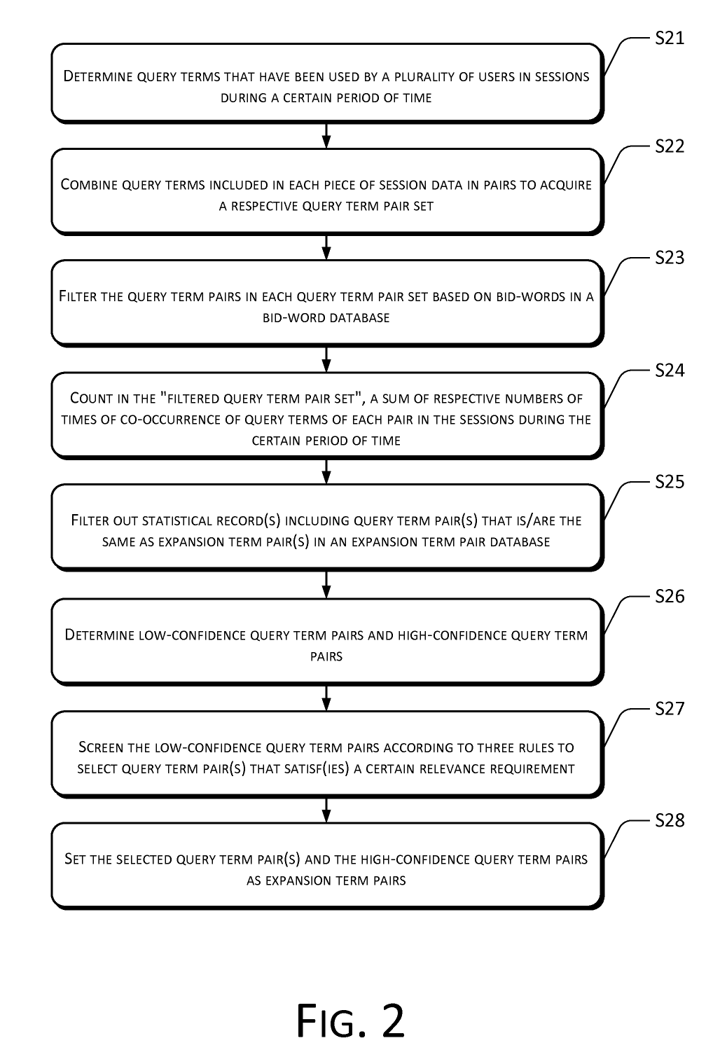

Furthermore, an embodiment of the present disclosure provides another method of selecting expansion term pairs. A flowchart of this method is shown in FIG. 2, which includes the following method blocks:

Block S21 determines query terms that have been used by a plurality of users in sessions during a certain period of time, e.g., the last three months, and stores query terms used by each user in different sessions according to a format as follows:

<sessionlD, time, query term 1, query term 2, query term 3, . . . >

“sessionlD” is a session identifier, and uniquely represents a session. “time” generally refers to a starting time and an ending time of the session. Query term 1, query term 2 and query term 3 are query terms used by a same user in a single session represented by sessionID.

For ease of description, an individual record having this format is referred to as “session data” hereinafter.

Block S22 combines query terms included in each piece of session data in pairs to acquire a respective query term pair set that corresponds to the respective piece of the session data and is constructed from query term pairs.

In an embodiment of the present disclosure, a format of the query term pair may be given as follows:

<query term 1, query term 2>

Block S23 filters the query term pairs in each query term pair set based on bid-words in a bid-word database. In particular implementations, block S23 may filter out query term pair(s) in which all respective query terms are not bid-words stored in the bid-word database.

For ease of description, a set including query terms that remain after filtering out the query term pair(s) in which all the respective query terms are not bid-words is referred to as a “filtered query term pair set” hereinafter. Different filtered query term pair sets correspond to different pieces of the session data.

Block S24 counts in the “filtered query term pair set”, a sum of respective numbers of times of co-occurrence of query terms of each pair in the sessions during the certain period of time, e.g., in the last three months, and generates statistical records having a format as follows according to a counting result:

<query term 1, query term 2, a sum of respective numbers of times of co-occurrence in different sessions in the last three months as 6>

Block S25 filters all the statistical records that are obtained at block S24 based on an expansion term pair database to remove statistical record(s) including query term pair(s) that is/are the same as expansion term pair(s) in the expansion term pair database to acquire remaining statistical records.

Block S26 determines query term pairs in which respective sums of numbers of times of co-occurrence are less than two in associated statistical records as “low-confidence query term pairs”, and query term pairs in which sum of respective numbers of times of co-occurrence are not less than two as “high-confidence query term pairs” according to the remaining statistical records.

Block S27 screens the low-confidence query term pairs according to three rules to select query term pair(s) that satisf(ies) a certain relevance requirement.

The three rules are given as follows:

First rule: if a number of times of any query term included in a low-confidence query term pair being used by users in different sessions in the last three months is one, a determination may be made that query terms in that low-confidence query term pair co-occur occasionally, thus determining that the low-confidence query term pair does not satisfy the relevance requirement.

Second rule: if query term units of two query terms included in a low-confidence query term pair have no overlap, the two query terms in that low-confidence query term pair are not semantically related, thus determining that the low-confidence query term pair does not satisfy the relevance requirement.

Third rule: if a lift degree between two query terms included in a low-confidence query term pair is less than a lift degree threshold, a determination may be made that the query terms in that low-confidence query term pair co-occur occasionally, thus determining that the low-confidence query term pair does not satisfy the relevance requirement.

Block S28 sets the query term pairs selected at block S27 and the high-confidence query term pairs determined at block S26 as expansion term pairs, so that the expansion term database may be updated based on these expansion term pairs.

Using the method provided by the embodiments of the present disclosure, since expansion term pairs may be determined from low-confidence query term pairs according to the three rules as described above, even in a scenario in which few high-confidence query term pairs exist due to insufficient user activities, expansion term pairs may still be determined from low-confidence query term pairs to acquire a relatively large number of expansion term pairs at the end, thus solving the problem that only a relatively small number of expansion term pairs can be determined in such scenario based on the existing method of determining expansion term pairs.

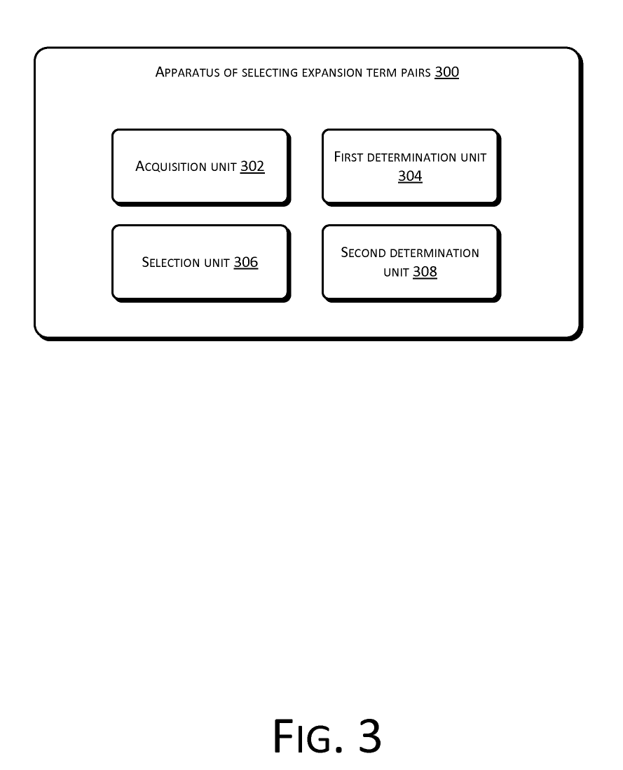

To solve the problem that only a small quantity of expansion term pairs can be determined based on the existing method of determining expansion term pairs under a circumstance that not enough user activities exist, the embodiments of the present disclosure further provide an apparatus 300 of selecting expansion term pairs. A structural diagram of the apparatus 300 is shown in FIG. 3, which includes an acquisition unit 302, a first determination unit 304 and a selection unit 306. Functions of these units are described hereinafter:

The acquisition unit 302 is configured to acquire at least two query term pairs, where each query term pair includes at least one query term as a bid-word.

The first determination unit 304 is configured to determine a query term pair in which a respective co-occurrence number of each query term included in a specific period of time is less than a first number-of-time threshold from among the at least two query term pairs acquired by the acquisition unit 302.

The selection unit 306 is configured to select a query term pair that satisfies a set expansion term pair necessary condition as an expansion term pair from among the query term pairs determined by the first determination unit 304.

In an embodiment, the selection unit 306 may use one of the seven approaches as described in the foregoing embodiments to select the expansion term pairs, which are not redundantly repeated herein.

Optionally, the apparatus 300 provided by the embodiments of the present disclosure may further include a second determination unit 308. The second determination unit 308 is configured to determine a query term pair in which a respective co-occurrence number of each query term included in the specific period of time is not less than the first number-of-time threshold as an expansion term pair from among the at least two query term pairs acquired by the acquisition unit 302.

Optionally, the at least two query term pairs acquired by the acquisition unit 31 include at least a first query term pair that is used by a first user as a basis for search in the specific period of time, and a second query term pair that is used by a second user as a basis for search in the specific period of time.

Optionally, the first determination unit 304 may further be configured to:

individually perform for each query term pair that is included in the at least two query term pairs, only used by a single user as a basis for search in a particular period of time and obtained by the acquisition unit 302: determining a respective number of times that the query term pair is used by a single user as a basis for search in the particular period of time; individually perform for each query term pair that is included in the at least two query term pairs, used by at least two users as a basis for search in the particular period of time and obtained by the acquisition unit 302: determining a respective total number of times that the query term pair is used by the users as a basis for search respectively in the particular period of time; and based on the respective number of times determined for each query term pair that is included in the at least two query term pairs, only used by a single user in the particular period of time and obtained by the acquisition unit 302, and the determined total number of times, determine a query term pair in which a respective co-occurrence number of each query term included in the particular period of time is less than a first number-of-time threshold.

Using the apparatus provided by the embodiments of the present disclosure, since query terms may be selected as expansion term pairs from among query term pairs in which a respective number of times of co-occurrence of each query term included in a particular period of time is less than a first number-of-time threshold based on a set expansion term pair necessary condition, more expansion term pairs may be acquired even in a scenario in which few high-confidence query term pairs exist due to insufficiently user activities, expansion term pairs may still be determined from low-confidence query term pairs to acquire a relatively large number of expansion term pairs at the end, thus solving the problem that only a relatively small number of expansion term pairs can be determined in such scenario based on the existing method of determining expansion term pairs.

One skilled in the art should understand that the embodiments of the present disclosure can be provided as a method, an apparatus (a system) or a product of a computer program. Therefore, the present disclosure can be implemented as an embodiment of only hardware, an embodiment of only software or an embodiment of a combination of hardware and software. Moreover, the present disclosure can be implemented as a product of a computer program that can be stored in one or more computer readable storage media (which includes but is not limited to, a magnetic disk, a CD-ROM or an optical disk, etc.) that store computer-executable instructions.

The present disclosure is described in accordance with flowcharts and/or block diagrams of the exemplary methods, terminal apparatuses (systems) and computer program products. It should be understood that each process and/or block and combinations of the processes and/or blocks of the flowcharts and/or the block diagrams may be implemented in the form of computer program instructions. Such computer program instructions may be provided to a general purpose computer, a special purpose computer, an embedded processor or another processing apparatus having a programmable data processing terminal device to generate a machine, so that an apparatus having the functions indicated in one or more blocks described in one or more processes of the flowcharts and/or one or more blocks of the block diagrams may be implemented by executing the instructions by the computer or the other processing apparatus having programmable data processing terminal device.

Such computer program instructions may also be stored in a computer readable memory device which may cause a computer or another programmable data processing mobile apparatus to function in a specific manner, so that a manufacture including an instruction apparatus may be built based on the instructions stored in the computer readable memory device. That instruction device implements functions indicated by one or more processes of the flowcharts and/or one or more blocks of the block diagrams.

The computer program instructions may also be loaded into a computer or another programmable data processing terminal apparatus, so that a series of operations may be executed by the computer or the other data processing terminal apparatus to generate a computer implemented process. Therefore, the instructions executed by the computer or the other programmable apparatus may be used to implement one or more processes of the flowcharts and/or one or more blocks of the block diagrams.

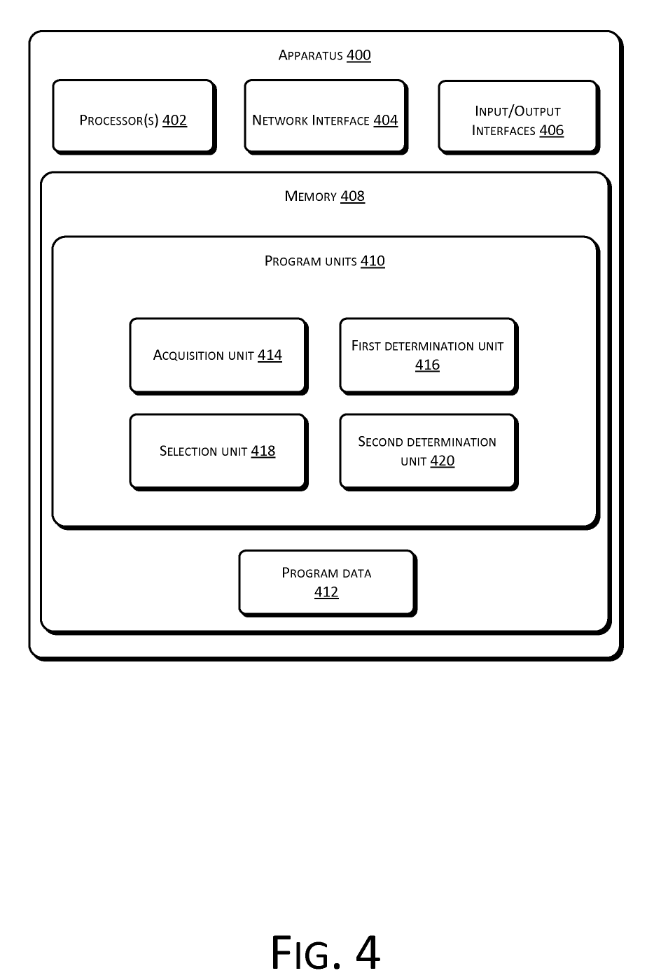

For example, FIG. 4 shows an example apparatus 400, such as the apparatus 300, in more details. In a typical configuration, the apparatus 400 may include one or more computing devices. In an embodiment, the apparatus 400 may include one or more processors (CPU) 402, an input/output interface 404, a network interface 406 and memory 408.

The memory 408 may include a form of computer readable media such as volatile memory, Random Access Memory (RAM), and/or non-volatile memory, e.g., Read-Only Memory (ROM) or flash RAM, etc. The memory 408 is an example of a computer readable media.

The computer readable media may include a permanent or non-permanent type, a removable or non-removable media, which may achieve storage of information using any method or technology. The information may include a computer-readable command, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In an embodiment, the memory 408 may include program units 410 and program data 412. The program units 410 may include an acquisition unit 414, a first determination unit 416, a selection unit 418 and a second determination unit 420. Details of these units have been described in the foregoing description, and therefore are not repeatedly described herein.

It should also be noted that terms such as “comprise”, “include” or any other variations thereof are meant to cover the non-exclusive inclusions. The process, method, product or apparatus that includes a series of elements not only includes those elements, but also includes other elements that are not explicitly listed, or further includes elements that already existed in such process, method, product or apparatus. In a condition without further limitations, an element defined by the phrase “include a/an . . . ” does not exclude any other similar elements from existing in the process, method, product or apparatus.

One skilled in the art should understand that the embodiments of the present disclosure can be provided as a method, a system or a computer program product. Therefore, the present disclosure can be implemented as an embodiment of only hardware, an embodiment of only software or an embodiment of a combination of hardware and software. Moreover, the present disclosure can be implemented as a computer program product that may be stored in one or more computer readable storage media (which includes but is not limited to, a magnetic disk, a CD-ROM or an optical disk, etc.) that store computer-executable instructions.

The above descriptions are merely exemplary embodiments of the present disclosure, and are not intended to limit the present disclosure. Any modifications, equivalent replacements and improvements, etc., made within the spirit and principle of the present disclosure should be included in the protection scope of the present disclosure.

What is claimed is:

1. A method implemented by one or more computing devices, the method comprising:
obtaining at least two query term pairs, each query term pair of the at least two query term pairs including at least one query term as a bid-word;
determining that a respective number of times of co-occurrence of each query term included in at least one query term pair within a specific period of time is less than a first number-of-time threshold from among the at least two query term pairs; and
selecting one or more query term pairs that satisfy a condition as one or more expansion term pairs from among the at least one query term pair.

2. The method of claim 1, wherein selecting the one or more query term pairs comprises selecting a query term pair that satisfies the condition as an expansion term pair based at least in part on a respective number of times of each query term included in the query term pair being used by different users as a basis for search in the specific period of time.

3. The method of claim 2, wherein the condition comprises the respective number of times of each query term included in the query term pair being used by the different users as the basis for the search in the specific period of time being greater than a second number-of-time threshold.

4. The method of claim 1, wherein selecting the one or more query term pairs comprises selecting a query term pair that satisfies the condition as an expansion term pair based at least in part on a respective number of times of each query term included in the query term pair being used by different users as a basis for search in the specific period of time and a respective coincidence degree of query term units of each query term included in the query term pair.

5. The method of claim 4, wherein the condition comprises:
the respective number of times of each query term included in the query term pair being used by the different users as the basis for the search in the specific period of time being greater than a second number-of-time threshold; and
a query term unit coincidence condition being satisfied, wherein the query term pair includes a first query term and a second query term, and the query term unit coincidence condition comprises at least one query term unit of the first query term being the same as a query term unit of the second query term.

6. The method of claim 1, wherein selecting the one or more query term pairs comprises selecting a query term pair that satisfies the condition as an expansion term pair based at least in part on a respective number of times of each query term included in the query term pair being used by different users as a basis for search in the specific period of time, a respective coincidence degree of query term units of each query term included in the query term pair, and a lift degree of query terms included in the query term pair.

7. The method of claim 1, wherein the condition comprises:
the respective number of times of each query term included in the query term pair being used by the different users as the basis for the search in the specific period of time being greater than a second number-of-time threshold;
a query term unit coincidence condition being satisfied, wherein the query term pair includes a first query term and a second query term, and the query term unit coincidence condition comprises at least one query term unit of the first query term being the same as a query term unit of the second query term; and
a value of the lift degree of the query terms included in the query term pair being greater than a lift degree threshold.

8. The method of claim 1, wherein selecting the one or more query term pairs comprises selecting a query term pair that satisfies the condition as an expansion term pair based at least in part on a respective number of times of each query term included in the query term pair being used by different users as a basis for search in the specific period of time, and a lift degree of query terms included in the query term pair.

9. The method of claim 1, wherein selecting the one or more query term pairs comprises selecting a query term pair that satisfies the condition as an expansion term pair based at least in part on a respective coincidence degree of query term units of each query term included in the query term pair, and a lift degree of query terms included in the query term pair.

10. The method of claim 9, wherein the condition comprises:
a query term unit coincidence condition being satisfied, wherein the query term pair includes a first query term and a second query term, and the query term unit coincidence condition comprises at least one query term unit of the first query term being the same as a query term unit of the second query term; and
a value of the lift degree of the query terms included in the query term pair being greater than a lift degree threshold.

11. The method of claim 1, wherein selecting the one or more query term pairs comprises selecting a query term pair that satisfies the condition as an expansion term pair based at least in part on a lift degree of query terms included in the query term pair, and wherein the condition comprises a value of the lift degree of the query terms included in the query term pair being greater than a lift degree threshold.

12. The method of claim 1, further comprising determining a query term pair as an expansion term pair from among the at least two query term pairs, a respective number of times of co-occurrence of each query term included in the query term pair within the specific period of time being not less than the first number-of-time threshold.

13. The method of claim 1, wherein the at least two query term pairs comprise at least a first query term pair that is used by a first user as the basis for the search in the specific period of time, and a second query term pair that is used by a second user as the basis for the search in the specific period of time.

14. An apparatus comprising:
one or more processors;
memory;
an acquisition unit stored in the memory and executable by the one or more processors to acquire at least two query term pairs, each query term pair of the at least two query term pairs including at least one query term as a bid-word;
a first determination unit stored in the memory and executable by the one or more processors to determine that a respective number of times of co-occurrence of each query term included in at least one query term pair within a specific period of time is less than a first number-of-time threshold from among the at least two query term pairs; and
a selection unit stored in the memory and executable by the one or more processors to select one or more query term pairs that satisfy a condition as one or more expansion term pairs from among the at least one query term pair.

15. The apparatus of claim 14, wherein the selection unit selects a query term pair that satisfies the condition as an expansion term pair based at least in part on a respective number of times of each query term included in the query term pair being used by different users as a basis for search in the specific period of time.

16. The apparatus of claim 15, wherein the condition comprises the respective number of times of each query term included in the query term pair being used by the different users as the basis for the search in the specific period of time being greater than a second number-of-time threshold.

17. The apparatus of claim 14, wherein the selection unit selects a query term pair that satisfies the condition as an expansion term pair based at least in part on a respective number of times of each query term included in the query term pair being used by different users as a basis for search in the specific period of time and a respective coincidence degree of query term units of each query term included in the query term pair.

18. The apparatus of claim 17, wherein the condition comprises:
the respective number of times of each query term included in the query term pair being used by the different users as the basis for the search in the specific period of time being greater than a second number-of-time threshold; and
a query term unit coincidence condition being satisfied, wherein the query term pair includes a first query term and a second query term, and the query term unit coincidence condition comprises at least one query term unit of the first query term being the same as a query term unit of the second query term.

19. The apparatus of claim 14, wherein the selection unit selects a query term pair that satisfies the condition as an expansion term pair based at least in part on a respective number of times of each query term included in the query term pair being used by different users as a basis for search in the specific period of time, a respective coincidence degree of query term units of each query term included in the query term pair, and a lift degree of query terms included in the query term pair, wherein the condition comprises:
the respective number of times of each query term included in the query term pair being used by the different users as the basis for the search in the specific period of time being greater than a second number-of-time threshold;
a query term unit coincidence condition being satisfied, wherein the query term pair includes a first query term and a second query term, and the query term unit coincidence condition comprises at least one query term unit of the first query term being the same as a query term unit of the second query term; and
a value of the lift degree of the query terms included in the query term pair being greater than a lift degree threshold.

20. One or more computer-readable media storing executable instructions that, when executed by one or more processors, cause the one or more processors to perform acts comprising:
obtaining at least two query term pairs, each query term pair of the at least two query term pairs including at least one query term as a bid-word;
determining that a respective number of times of co-occurrence of each query term included in at least one query term pair within a specific period of time is less than a first number-of-time threshold from among the at least two query term pairs; and
selecting one or more query term pairs that satisfy a condition as one or more expansion term pairs from among the at least one query term pair.
